(19) United States
(12) Patent Application Publication
(10) Pub. No.: US 2020/0091522 A1
(43) Pub. Date: Mar. 19, 2020

(54) ALL SOLID BATTERY

(71) Applicant: TAIYO YUDEN CO., LTD., Tokyo (JP)

(72) Inventors: Daigo ITO, Takasaki-shi (JP); Takato SATOH, Takasaki-shi (JP); Sachie TOMIZAWA, Takasaki-shi (JP); Chie KAWAMURA, Takasaki-shi (JP)

(21) Appl. No.: 16/568,005

(22) Filed: Sep. 11, 2019

(30) Foreign Application Priority Data
Sep. 19, 2018 (JP) 2018-174699

(51) Int. Cl. H01M 6/18; H01M 10/0562; H01M 4/40; H01M 4/58

(52) U.S. Cl. CPC H01M 6/18; H01M 4/5805; H01M 4/405; H01M 10/0562

(57) ABSTRACT

An all solid battery includes: a solid electrolyte layer of which a main component is phosphoric acid salt-based solid electrolyte; a positive electrode layer that is formed on a first main face of the solid electrolyte layer; and a negative electrode layer that is formed on a second main face of the solid electrolyte layer, wherein the positive electrode layer includes a positive electrode active material and a solid electrolyte, wherein a discharge capacity of the solid electrolyte of the positive electrode layer is 20% to 50% on a presumption that a discharge capacity of the positive electrode active material is 100%.

### CROSS-REFERENCE TO RELATED APPLICATION

This application is based upon and claims the benefit of priority of the prior Japanese Patent Application No. 2018-174699, filed on Sep. 19, 2018, the entire contents of which are incorporated herein by reference.

### FIELD

A certain aspect of the present invention relates to an all solid battery.

### BACKGROUND

There is disclosed thin film batteries of all solid type having an electrode layer composed of electrode active material (for example, see Japanese Patent Application Publication No. S59-31570). In these batteries, a ratio of the electrode active material in the electrode layer is 100%. Therefore, when only the electrode layer is focused on, capacity density is very high. However, the electrode layer is formed by a sputtering method, a vapor deposition method, a CVD method or the like. Therefore, the electrode layer is very thin. This results in small effective capacity.

For the purpose of achieving a large effective capacity in the all solid batteries, it is preferable that the electrode layer has a large thickness. However, when the electrode layer having a large thickness is composed of the electrode active material, ionic conductivity or electron conductivity is not achieved. Therefore, the electrode active material of the electrode layer does not operate favorably. And so, for the purpose of operating the electrode active material in the electrode layer, a method of compounding various materials is supposed. The electrode layer of the all solid batteries generally includes an electrode active material (positive electrode material or negative electrode material), a conductive auxiliary agent achieving electron conductivity, an ionic assistant (solid electrolyte) achieving ionic conductivity. For example, there is disclosed a technology in which vanadium pentoxide V₂O₅ is used as the positive electrode active material, polymer solid electrolyte is used as an ionic assistant, and acetylene black is used as the electron conductive agent (conductive auxiliary agent). The materials are compounded. And a positive electrode sheet is formed (for example, see Japanese Patent Application Publication No. H5-283106).

In lithium ion batteries using electrolyte solution, the electrolyte solution intrudes into micro gap of an electrode layer even if the ionic assistant is not added. Therefore, it is not necessary to provide the ionic assistant in the electrode layer. However, the all solid batteries do not use the electrolyte solution. It is therefore preferable that solid electrolyte is provided in the electrode layer in advance.

### SUMMARY OF THE INVENTION

It is preferable that the solid electrolyte is provided in the electrode layer with a predetermined volume ratio or more, from a viewpoint of sufficiently securing an ionic path in the electrode layer. On the other hand, this causes reduction of the ratio of the active material in the electrode layer. That is, the solid electrolyte in the electrode layer does not contribute to the capacity. Moreover, when the amount of the solid electrolyte is excessively large, the capacity density may be degraded.

The present invention has a purpose of providing an all solid battery that is capable of improving battery capacity.

According to an aspect of the present invention, there is provided an all solid battery including: a solid electrolyte layer of which a main component is phosphoric acid salt-based solid electrolyte; a positive electrode layer that is formed on a first main face of the solid electrolyte layer; and a negative electrode layer that is formed on a second main face of the solid electrolyte layer, wherein the positive electrode layer includes a positive electrode active material and a solid electrolyte, wherein a discharge capacity of the solid electrolyte of the positive electrode layer is 20% to 50% on a presumption that a discharge capacity of the positive electrode active material is 100%.

### BRIEF DESCRIPTION OF THE DRAWINGS

FIG. 1 illustrates a schematic cross section of an all solid battery;

FIG. 2 illustrates a discharge curve;

FIG. 3 illustrates a schematic cross section of another all solid battery;

FIG. 4 illustrates a flowchart of a manufacturing method of an all solid battery;

FIG. 5 illustrates a stacking process;

FIG. 6A illustrates a discharge curve;

FIG. 6B illustrates a recycle characteristic capacity of discharge capacity;

FIG. 7A illustrates a discharge curve;

FIG. 7B illustrates a recycle characteristic capacity of discharge capacity;

FIG. 8A illustrates a discharge curve; and

FIG. 8B illustrates a recycle characteristic capacity of discharge capacity.

### DETAILED DESCRIPTION

A description will be given of an embodiment with reference to the accompanying drawings.

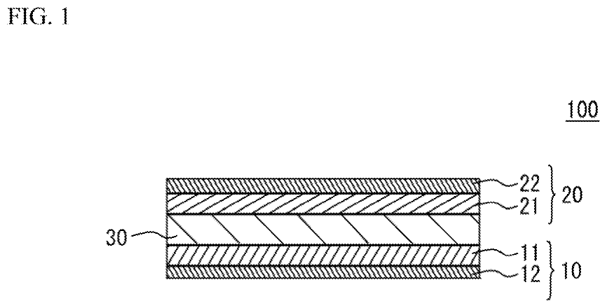

FIG. 1 illustrates a schematic cross section of an all solid battery 100. As illustrated in FIG. 1, the all solid battery 100 has a structure in which a positive electrode 10 and a negative electrode 20 sandwich a phosphoric acid salt-based solid electrolyte layer 30. The positive electrode 10 is provided on a first main face of the solid electrolyte layer 30. The positive electrode 10 has a structure in which a positive electrode layer 11 and an electric collector layer 12 are stacked. The positive electrode layer 11 is on the solid electrolyte layer 30 side. The negative electrode 20 is provided on a second main face of the solid electrolyte layer 30. The negative electrode 20 has a structure in which a negative electrode layer 21 and an electric collector layer 22 are stacked. The negative electrode layer 21 is on the solid electrolyte layer 30 side.

At least, the solid electrolyte layer 30 is a phosphoric acid salt-based solid electrolyte. For example, the phosphoric acid salt-based electrolyte has a NASICON structure. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, it is preferable that Li—Al—Ge—PO₄-based material, to which a transition metal included in the phosphoric acid salt having the olivine type crystal structure included in the positive electrode layer 11 and the negative electrode layer 21 is added in advance, is used. For example, when the positive electrode layer 11 and the negative electrode layer 21 include phosphoric acid salt including Co and Li, it is preferable that the solid electrolyte layer 30 includes Li—Al—Ge—PO₄-based material to which Co is added in advance. In this case, it is possible to suppress solving of the transition metal included in the electrode active material into the electrolyte.

At least, the positive electrode layer 11 includes a material having an olivine type crystal structure, as an electrode active material. It is preferable that the negative electrode layer 21 also includes the electrode active material. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal.

The electrode active material having the olivine type crystal structure acts as a positive electrode active material in the positive electrode layer 11. For example, when only the positive electrode layer 11 includes the electrode active material having the olivine type crystal structure, the electrode active material acts as the positive electrode active material. When the negative electrode layer 21 also includes an electrode active material having the olivine type crystal structure, discharge capacity may increase and an operation voltage may increase because of electric discharge, in the negative electrode layer 21. The function mechanism is not completely clear. However, the mechanism may be caused by partial solid-phase formation together with the negative electrode active material.

When both the positive electrode layer 11 and the negative electrode layer 21 include an electrode active material having the olivine type crystal structure, the electrode active material of each of the positive electrode layer 11 and the negative electrode layer 21 may have a common transition metal. Alternatively, the a transition metal of the electrode active material of the positive electrode layer 11 may be different from that of the negative electrode layer 21. The positive electrode layer 11 and the negative electrode layer 21 may have only single type of transition metal. The positive electrode layer 11 and the negative electrode layer 21 may have two or more types of transition metal. It is preferable that the positive electrode layer 11 and the negative electrode layer 21 have a common transition metal. It is more preferable that the electrode active materials of the both electrode layers have the same chemical composition. When the positive electrode layer 11 and the negative electrode layer 21 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The negative electrode layer 21 may include known material as the negative electrode active material. When only one of the electrode layers includes the negative electrode active material, it is clarified that the one of the electrode layers acts as a negative electrode and the other acts as a positive electrode. When only one of the electrode layers includes the negative electrode active material, it is preferable that the one of the electrode layers is the negative electrode layer 21. Both of the electrode layers may include the known material as the negative electrode active material. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate.

In the forming process of the positive electrode layer 11 and the negative electrode layer 21, moreover, oxide-based solid electrolyte material or a conductive material (conductive auxiliary agent) such as a carbon or a metal may be added. The conductive auxiliary agent is added to the positive electrode layer 11 and the negative electrode layer 21 in order to achieve electron conductivity in the positive electrode layer 11 and the negative electrode layer 21. The solid electrolyte is added to the positive electrode layer 11 and the negative electrode layer 21 in order to achieve ionic conductivity in the positive electrode layer 11 and the negative electrode layer 21. When the material is evenly dispersed into water or organic solution together with binder or plasticizer, paste for electrode layer is obtained. Pd, Ni, Cu, or Fe, or an alloy thereof may be used as a metal of the conductive auxiliary agent.

In the all solid battery 100, during charging, Li⁺is released from the active material of the positive electrode layer 11 and moves to the negative electrode layer 21 via the solid electrolyte layer 30. On the other hand, during discharging, Li⁺returns to the positive electrode layer 11 from the negative electrode layer 21 via the solid electrolyte layer 30, and is inserted into the active material of the positive electrode layer 11 again. In the embodiment, the positive electrode layer 11 includes solid electrolyte from which Li is released. The solid electrolyte of the positive electrode layer 11 contributes to a battery capacity and improves the battery capacity of the all solid battery 100.

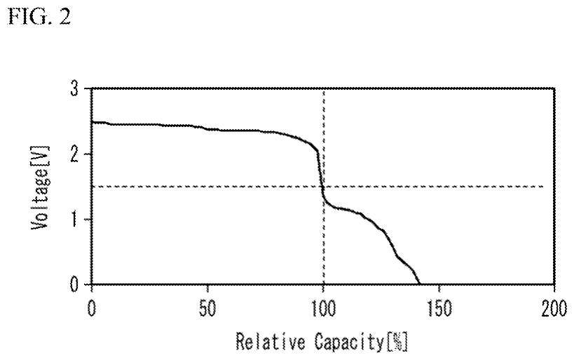

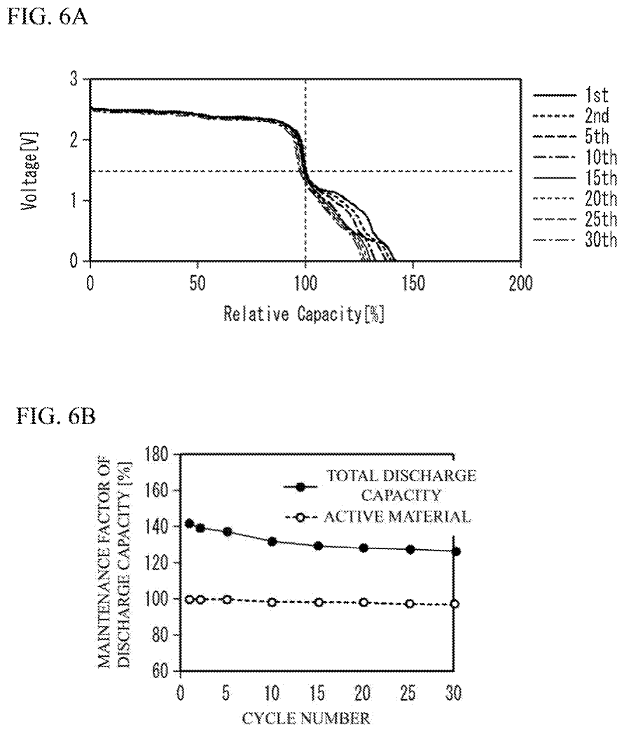

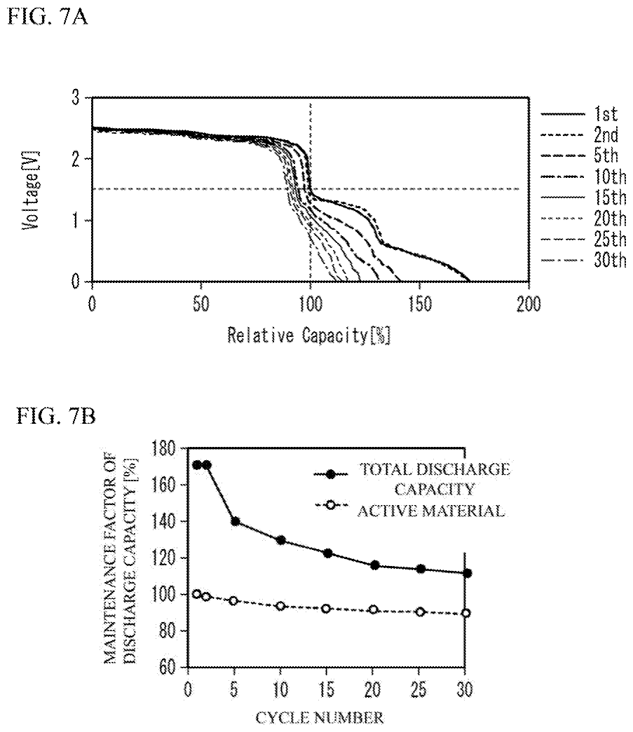

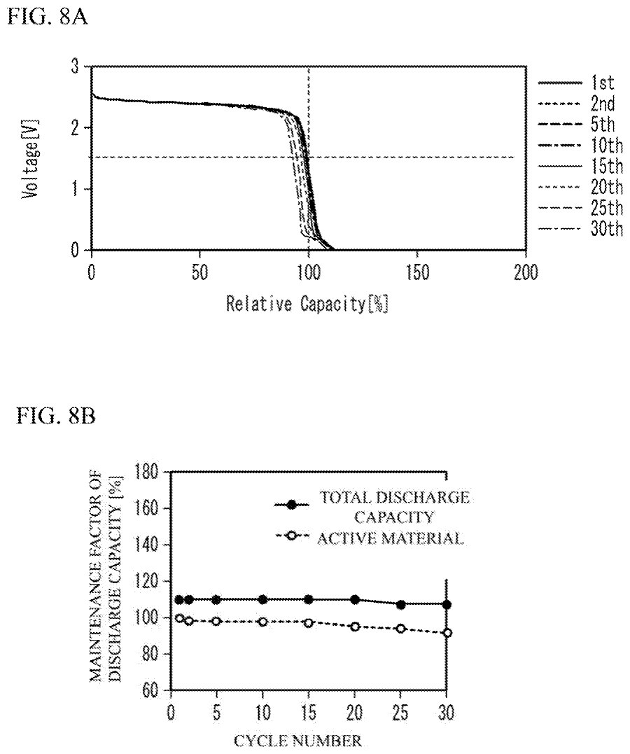

In addition to the discharge and charge reaction of the active material of the positive electrode layer 11, it is possible to estimate a ratio of the discharge and charge reaction in which Li is released from the solid electrolyte of the positive electrode layer 11 during charging and Li is inserted into the solid electrolyte again during discharging, from the discharge curve. FIG. 2 illustrates the discharge curve. In FIG. 2, a horizontal axis indicates the discharge capacity of the all solid battery 100 (a relative value which is to be 10% at 1.5 V of a first cycle. The same things applies to FIG. 6A, FIG. 7A and FIG. 8A). A vertical axis indicates the discharge voltage of the all solid battery 100. In the example of FIG. 2, the positive electrode active material is LiCoPO₄, and the negative electrode active material is Li₁₊ₓAlₓTi₂₋ₓ(PO₄)₃. A solid electrolyte from which Li is released is added to the positive electrode layer 11. In this case, a first discharge voltage of the all solid battery 100 is approximately 2.3 V to 2.4 V. In the example of FIG. 2, a second discharge voltage is obtained around 1.2 V, in addition to the first discharge voltage. The second discharge voltage is caused by the Li release from the solid electrolyte added to the positive electrode layer 11. In the embodiment, a ratio of the discharge capacity which is cut at 1.5 V with respect to the whole discharge capacity is estimated as a capacity ratio of the active material. The rest discharge capacity from 1.5 V to 0 V is estimated as a capacity ratio of the solid electrolyte.

The capacity ratio changes according to the composition condition of the solid electrolyte. When the capacity ratio of the solid electrolyte in the positive electrode layer 11 is excessively large, a reduction amount of ionic conduction of the solid electrolyte of the positive electrode layer 11 is large. In this case, Li is released during charging, and Li is hardly inserted into the solid electrolyte during discharging. Therefore, coulombic efficiency is reduced. And, when the discharge and charge cycle is repeated, increasing of resistance caused by reduction of the ionic conduction occurs because of gradual releasing of Li from the solid electrolyte. And the capacity of the active material is reduced. And so, the capacity ratio of the solid electrolyte has an upper limit. The present inventors have found that it is not preferable that the discharge capacity of the solid electrolyte is more than 50% on a presumption that the discharge capacity of the active material is 100%, because the defect may occur. And so, it is preferable that the discharge capacity of the solid electrolyte of the positive electrode layer 11 is 50% or less on a presumption that the discharge capacity of the active material is 100%. It is more preferable that the discharge capacity of the solid electrolyte is 45% or less. On the other hand, when the capacity ratio of the solid electrolyte is excessively small, sufficient effect may not be necessarily achieved from a viewpoint of improvement of energy density. And so, in the embodiment, in the positive electrode layer 11, it is preferable that the discharge capacity of the solid electrolyte is 20% or more on a presumption that the discharge capacity of the active material is 100%. It is more preferable that the discharge capacity of the solid electrolyte is 25% or more.

The discharge capacity of the active material in the positive electrode layer 11 is an electrical capacity of Li movement from the negative electrode active material in the negative electrode layer 21 to the positive electrode active material in the positive electrode layer 11, in the discharging of the all solid battery 100. The discharge capacity of the active material of the positive electrode layer 11 is defined as a discharge capacity until a voltage which is lower than a difference voltage between an oxidation-reduction potential of the positive electrode active material and an oxidation-reduction potential of the negative electrode active material (normal operation voltage of cell) by 1 V. The discharge capacity of the solid electrolyte is defined as a discharge capacity in a voltage range which is lower than a voltage lower than the difference voltage by 1 V.

The solid electrolyte added to the positive electrode layer 11 is phosphoric acid salt having the NASICON type structure. For example, the solid electrolyte is LiM₂(PO₄)₃ in which a transition metal of which a valence is 4 such as Ti, Ge, Sn, Hf or Zr occupies a part of all of M, Li₁₊ₓAₓM₂₋ₓ(PO₄)₃ in which a metal of which a valence is 3 such as Al, Ga, In, Y or La occupies a part or all of M, or the like. For example, the solid electrolyte is Li₁₊ₓAlₓM₂₋ₓ(PO₄)₃ in which A is Al. The oxide-based solid electrolyte added to the negative electrode layer 21 is phosphoric acid salt having the NASICON type structure. For example, the oxide-based solid electrolyte is Li₁₊ₓAlₓTi₂₋ₓ(PO₄)₃ or the like.

From a viewpoint of securing conduction path of ions, it is preferable that a ratio of the solid electrolyte in the positive electrode layer 11 is 20 vol. % or more. On the other hand, from a viewpoint of increasing the ratio of the capacity at a regular voltage (voltage caused by the active material), it is preferable that the existence ratio of the active material in the positive electrode layer 11 is 30 vol. % or more. That is, it is preferable that the ratio of the solid electrolyte in the positive electrode layer 11 is 70 vol. % or less. From a viewpoint of securing the conduction path of ions, it is preferable that the ratio of the solid electrolyte in the positive electrode layer 11 is 10 vol. % or more. It is more preferable that the ratio of the solid electrolyte in the positive electrode layer 11 is 15 vol. % or more. It is still more preferable that the ratio of the solid electrolyte in the positive electrode layer 11 is 20 vol. % or more. On the other hand, from a view point increasing the ratio of the capacity at a regular voltage (voltage caused by the active material), it is preferable that the ratio of the active material in the positive electrode layer 11 is 30 vol. % or more. It is more preferable that the ratio of the active material in the positive electrode layer 11 is 40 vol. % or more. It is still more preferable that the ratio of the active material in the positive electrode layer 11 is 50 vol. % or more. It is preferable that the ratio of the solid electrolyte in the positive electrode layer 11 is 70 vol. % or less. It is more preferable that the ratio of the solid electrolyte in the positive electrode layer 11 is 60 vol. % or less. It is still more preferable that the ratio of the solid electrolyte in the positive electrode layer 11 is 50 vol. % or less.

From a viewpoint of securing capacity of the positive electrode layer 11, it is preferable that the positive electrode layer 11 is thick. For example, it is preferable that the thickness of the positive electrode layer 11 is 2 μm or more. It is more preferable that the thickness of the positive electrode layer 11 is 5 μm or more. It is still more preferable that the thickness of the positive electrode layer 11 is 10 μm or more. From a viewpoint of securing response of the solid electrolyte layer 30, it is preferable that the solid electrolyte layer 30 is thin. For example, it is preferable that the thickness of the solid electrolyte layer 30 is 20 μm or less. It is more preferable that the thickness of the solid electrolyte layer 30 is 10 μm or less. It is still more preferable that the thickness of the solid electrolyte layer 30 is 5 μm or less.

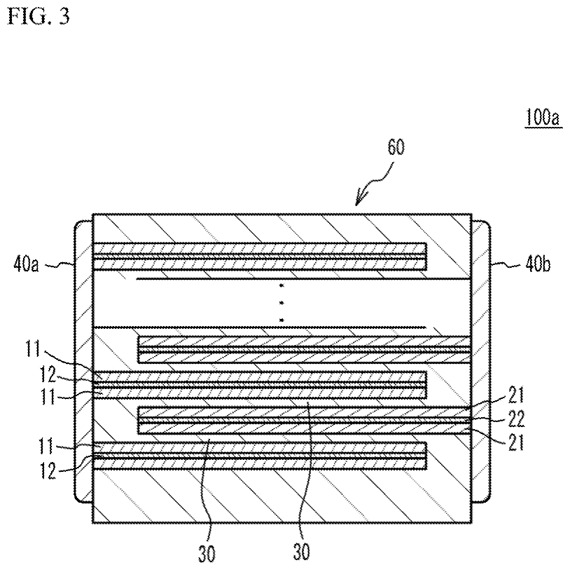

FIG. 3 illustrates a schematic cross section of an all solid battery 100a in accordance with another embodiment. The all solid battery 100a has a multilayer chip 60 having a rectangular parallelepiped shape, a first external electrode 40a provided on a first edge face of the multilayer chip 60, and a second external electrode 40b provided on a second edge face facing with the first edge face. In the following description, the same numeral is added to each member that is the same as that of the all solid battery 100. And, a detail explanation of the same member is omitted.

In the all solid battery 100a, each of the electric collector layers 12 and each of the electric collector layers 22 are alternately stacked. Edges of the electric collector layers 12 are exposed to the first edge face of the multilayer chip 60 but are not exposed to the second edge face of the multilayer chip 60. Edges of the electric collector layers 22 are exposed to the second edge face of the multilayer chip 60 but are not exposed to the first edge face. Thus, each of the electric collector layers 12 and each of the electric collector layers 22 are alternately conducted to the first external electrode 40a and the second external electrode 40b.

The positive electrode layer 11 is stacked on the electric collector layer 12. The solid electrolyte layer 30 is stacked on the positive electrode layer 11. The solid electrolyte layer 30 extends from the first external electrode 40a to the second external electrode 40b. The negative electrode layer 21 is stacked on the solid electrolyte layer 30. The electric collector layer 22 is stacked on the negative electrode layer 21. Another negative electrode layer 21 is stacked on the electric collector layer 22. Another solid electrolyte layer 30 is stacked on the negative electrode layer 21. The solid electrolyte layer 30 extends from the first external electrode 40a to the second external electrode 40b. The positive electrode layer 11 is stacked on the solid electrolyte layer 30. In the all solid battery 100a, the stack units are repeatedly stacked. Therefore, the all solid battery 100a has a structure in which a plurality of cell units are stacked.

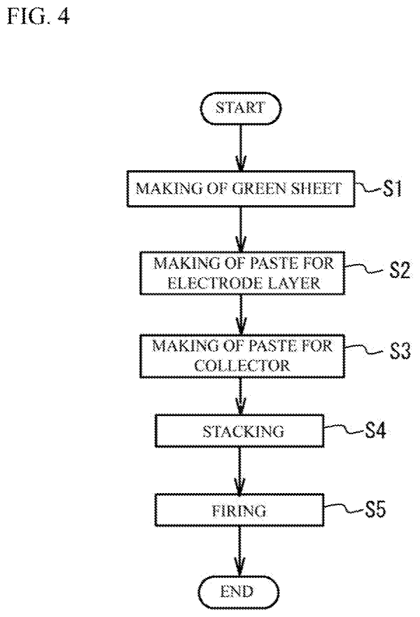

FIG. 4 illustrates a flowchart of the manufacturing method of the all solid battery 100 and the all solid battery 100a.

(Making process of green sheet) Powder of the phosphoric acid salt-based solid electrolyte structuring the solid electrolyte layer 30 is made. For example, it is possible to make the powder of the phosphoric acid salt-based solid electrolyte structuring the solid electrolyte layer 30, by mixing raw material and additives and using solid phase synthesis method or the like. The resulting powder is subjected to dry grinding. Thus, a grain diameter of the resulting power is adjusted to a desired one. For example, the grain diameter of the resulting power is adjusted to a desired one by a planetary ball mil using ZrO₂ balls having a diameter of 5 mm φ.

The resulting powder is evenly dispersed into aqueous solvent or organic solvent together with a binding agent, a dispersing agent, a plasticizer and so on. The resulting power is subjected wet crushing. And solid electrolyte slurry having a desired grain diameter is obtained. In this case, a bead mill, a wet jet mill, a kneader, a high pressure homogenizer or the like may be used. It is preferable that the bead mill is used because adjusting of particle size distribution and dispersion are performed at the same time. A binder is added to the resulting solid electrolyte slurry. Thus, solid electrolyte paste is obtained. The solid electrolyte paste is coated. Thus, a green sheet is obtained. The coating method is not limited. For example, a slot die method, a reverse coat method, a gravure coat method, a bar coat method, a doctor blade method or the like may be used. It is possible to measure grain diameter distribution after the wet crushing, with use of a laser diffraction measuring device using a laser diffraction scattering method.

(Making process of paste for electrode layer) Next, paste for electrode layer is made in order to make the positive electrode layer 11 and the negative electrode layer 21. For example, a conductive auxiliary agent, an active material, a solid electrolyte material, a binder, a plasticizer and so on are evenly dispersed into water or organic solvent. Thus, paste for electrode layer is obtained. The above-mentioned solid electrolyte paste may be used as the solid electrolyte material. Carbon materials can be used as the conductive auxiliary agent. When the composition of the positive electrode layer 11 is different from that of the negative electrode layer 21, paste for electrode layer used for the positive electrode layer 11 and another paste for electrode layer used for the negative electrode layer 21 may be individually made.

(Making process of paste for electric collector) Next, paste for electric collector is made in order to make the electric collector layer 12 and the electric collector layer 22. It is possible to make the paste for electric collector, by evenly dispersing powder of Pd, a binder, dispersant, plasticizer and so on into water or organic solvent.

(Stacking process) The paste for electrode layer and the paste for electric collector are printed on both faces of the green sheet, with respect to the all solid battery 100 described on the basis of FIG. 1. The printing method is not limited. For example, a screen printing method, an intaglio printing method, a letter press printing method, a calendar roll printing method or the like may be used. In order to make a stacked device having a thin layer and a large number of stacked layers, the screen printing is generally used. However, an ink jet printing may be preferable when a micro size electrode pattern or a special shape is necessary.

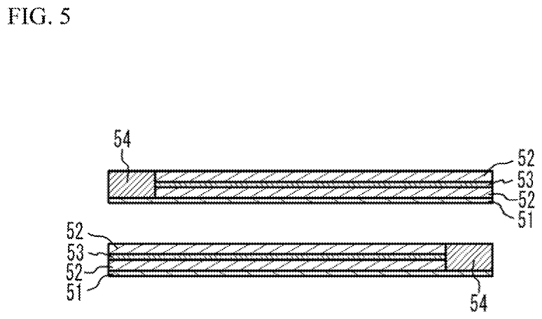

With respect to the all solid battery 100a described on the basis of FIG. 3, paste 52 for electrode layer is printed on one face of a green sheet 51 as illustrated in FIG. 5. Paste 53 for electric collector is printed on the paste 52 for electrode layer. And, another paste 52 for electrode layer is printed on the paste 53 for electric collector. A reverse pattern 54 is printed on a part of the green sheet 51 where neither the paste 52 for electrode layer nor the paste 53 for electric collector is printed. A material of the reverse pattern 54 may be the same as that of the green sheet 51. The green sheets 51 after printing are stacked so that each of the green sheets 51 is alternately shifted to each other. Thus, a multilayer structure is obtained. In this case, in the multilayer structure, a pair of the paste 52 for electrode layer and the paste 53 for electric collector are alternately exposed to the two edge faces of the multilayer structure.

(Firing process) Next, the resulting multilayer structure is fired. In the firing process, it is preferable that a maximum temperature is 400 degrees C. to 1000 degrees C. It is more preferable that that maximum temperature is 500 degrees C. to 900 degrees C. In order to sufficiently remove the binder until the maximum temperature, a process for keeping a temperature lower than the maximum temperature in an oxidizing atmosphere may be performed. It is preferable that the firing is performed in the lowest possible temperature, from a viewpoint of reduction of the process cost. After the firing, a re-oxidizing process may be performed. In this manner, the all solid battery 100 or the all solid battery 100a is manufactured.

### EXAMPLES

### Example 1

In the positive electrode layer 11, Li_{1.3}Al_{0.3}Ti_{1.7}(PO₄)₃ was used as the solid electrolyte, LiCoPO₄ was used as the positive electrode active material, and Pd was used as the conductive auxiliary agent. The volume ratio among the solid electrolyte, the positive electrode active material and the conductive auxiliary agent was 1:1:1. The composition of a part of the solid electrolyte layer 30 near the positive electrode layer 11 was Li_{1.3}Al_{0.3}Ge_{1.7}(PO₄)₃. In the negative electrode layer 21, Li_{1.3}Al_{0.3}Ti_{1.7}(PO₄)₃ was used as the negative electrode active material.

In an initial discharge capacity, a discharge until 1.5 V was defined as a discharge capacity of the active material, and a discharge capacity from 1.5 V to 0 V was defined as a discharge capacity of the solid electrolyte. A ratio of an SE discharge was 42% on a presumption that the discharge capacity of the active material was 100%. That is, the discharge capacity of the solid electrolyte was 42% on a presumption that the discharge capacity of the active material was 100%, in the positive electrode layer 11. As illustrated in FIG. 6A, when the charging and discharging was repeated, the cycle characteristic was relatively favorable. In particular, the capacity achieved by the active material hardly changed even if the cycle was repeated. It is thought that this was because the discharge capacity of the solid electrolyte was 10% to 50% on a presumption that the discharge capacity of the active material was 100%; an amount of released Li from the solid electrolyte was limited to a predetermined value, Li was reversibly inserted again when the cycle was repeated; and the degradation of the ionic conduction was limited. As a result, as illustrated in FIG. 6B, the initial total discharge capacity was 142%. And the total discharge capacity at 30th cycle was 126%.

### Comparative Example 1

In the positive electrode layer 11, Li_{1.1}Al_{0.1}Ti_{1.9}(PO₄)₃ was used as the solid electrolyte, LiCoPO₄ was used as the positive electrode active material, and Pd was used as the conductive auxiliary agent. The volume ratio among the solid electrolyte, the positive electrode active material and the conductive auxiliary agent was 1:1:1. The composition of the part of the solid electrolyte layer 30 near the positive electrode layer 11 was Li_{1.3}Al_{0.3}Ge_{1.7}(PO₄)₃. In the negative electrode layer 21, Li_{1.3}Al_{0.3}Ti_{1.7}(PO₄)₃ was used as the negative electrode active material.

The ratio of the SE capacity was 71% on a presumption that the discharge capacity of the active material was 100%. That is, the discharge capacity of the solid electrolyte was 71% on a presumption that the discharge capacity of the active material was 100%, in the positive electrode layer 11. As illustrated in FIG. 7A, when the discharge and charge was repeated, it was confirmed that the capacity decreased as the cycle number increased. It is thought that this was because the discharge capacity of the solid electrolyte was more than 50% on a presumption that the discharge capacity of the active material was 100%; an amount of Li released from the solid electrolyte in the positive electrode layer was large; the ionic conductivity was degraded; an amount of an irreversible part increases; and the capacity was degraded. As a result, as illustrated in FIG. 7B, the initial total discharge capacity was 171%, but the total discharge capacity at 30th cycle was reduced to 112%.

### Comparative Example 2

In the positive electrode layer 11, Li_{1.3}Al_{0.3}Ge_{1.7}(PO₄)₃ was used as the solid electrolyte, LiCoPO₄ was used as the positive electrode active material, and Pd was used as the conductive auxiliary agent. The volume ratio among the solid electrolyte, the positive electrode active material and the conductive auxiliary agent was 1:1:1. The composition of the part of the solid electrolyte layer 30 near the positive electrode layer 11 was Li_{1.3}Al_{0.3}Ge_{1.7}(PO₄)₃. In the negative electrode layer 21, Li_{1.3}Al_{0.3}Ti_{1.7}(PO₄)₃ was used as the negative electrode active material.

The ratio of the SE capacity was 5% on a presumption that the capacity of the active material was 100%. That is, in the positive electrode layer 11, the discharge capacity of the solid electrolyte was 11% on a presumption that the discharge capacity of the active material was 100%. As illustrated in FIG. 8A, when the charging and discharging of the battery were repeated, the cycle characteristic was relatively favorable. However, the capacity achieved by the solid electrolyte was small. As a result, as illustrated in FIG. 8B, the initial total discharge capacity was 111%. The total discharge capacity at 30th cycle was 108%. Therefore, the solid electrolyte slightly contributed to the capacity. It is thought that this was because the discharge capacity of the solid electrolyte was less than 20% on a presumption that the discharge capacity of the active material was 100%.

Although the embodiments of the present invention have been described in detail, it is to be understood that the various change, substitutions, and alterations could be made hereto without departing from the spirit and scope of the invention.

What is claimed is:

1. An all solid battery comprising:
a solid electrolyte layer of which a main component is phosphoric acid salt-based solid electrolyte;
a positive electrode layer that is formed on a first main face of the solid electrolyte layer; and
a negative electrode layer that is formed on a second main face of the solid electrolyte layer,
wherein the positive electrode layer includes a positive electrode active material and a solid electrolyte,
wherein a discharge capacity of the solid electrolyte of the positive electrode layer is 20% to 50% on a presumption that a discharge capacity of the positive electrode active material is 100%.

2. The all solid battery as claimed in claim 1,
wherein the positive electrode active material is LiCoPO₄,
wherein the solid electrolyte of the positive electrode layer is LiM₂(PO₄)₃ or Li₁₊ₓAₓM₂₋ₓ(PO₄)₃ (M is a metal of which a valence is four, and A is a metal of which a valence is three).

3. The all solid battery as claimed in claim 1, wherein a ratio of the solid electrolyte in the positive electrode layer is 10 vol. % to 70 vol. %.

4. The all solid battery as claimed in claim 1, wherein the positive electrode layer includes a conductive auxiliary agent having electron conductivity.

5. The all solid battery as claimed in claim 1, further comprising an electric collector layer on a face of the solid electrolyte layer which is opposite to the positive electrode layer.
